(19) United States
(12) Patent Application Publication
(10) Pub. No.: US 2009/0289917 A1
(43) Pub. Date: Nov. 26, 2009

(54) DYNAMIC VISUAL FEATURE COORDINATION IN AN ELECTRONIC HAND HELD DEVICE

(76) Inventor: Samuel F. SAUNDERS, Lovingston, VA (US)

Correspondence Address: MCGUIREWOODS, LLP, 1750 TYSONS BLVD, SUITE 1800, MCLEAN, VA, 22102, US

(21) Appl. No.: 12/408,504

(22) Filed: Mar. 20, 2009

Related U.S. Application Data
(60) Provisional application No. 61/038,182, filed on Mar. 20, 2008.

(51) Int. Cl. G06F 3/045; G06F 3/041; G01D 13/00

(52) U.S. Cl. 345/174; 345/173; 116/205

(57) ABSTRACT

An apparatus and method for dynamic visual feature coordination in an electronic hand held device is described. In an embodiment, the apparatus includes key configurations arranged in a clock-like fashion and other configurations so that a user's finger might be easily tracked prior to actual key selection within the circular arrangement and other keys to facilitate a multitude of features that includes anticipation of a user's actions and also shows alternative information based at least in part on current, previous and projected next finger movements. In other embodiments, visual display presentations related to described feature operations and key configurations are described.

This application claims benefit and priority to U.S. Provisional Application No. 61/038,182 filed Mar. 20, 2008, entitled “DYNAMIC VISUAL FEATURE COORDINATION IN AN ELECTRONIC HAND HELD DEVICE,” the disclosure of which is incorporated by reference herein.

### BACKGROUND OF THE INVENTION

1.0 Field of Invention

The invention relates generally to organizing, presenting, controlling and coordinating visual displays in an electronic hand held device, and more particularly, to organizing, presenting, controlling and coordinating visual displays in an electronic hand held device that includes communications related features, such as for a cell phone, personal digital assistants (PDAs), and similar hand held electronic devices.

2.0 Related Art

Modern hand held electronic devices such as cell phones, personal digital assistants (PDAs), Blackberry type devices, and the like, typically include one or more modern features such as pushing e-mail, mobile telephone functions, text messaging, Internet faxing, web browsing and other wireless information services, just to name a few prominent features.

However, these features are typically arranged so that accessing such features are serial in nature, often lacking intuitive organization and control arrangement, or presented based on traditional “square-ish” type key pad (e.g., rectangular key layout) and button arrangement. Moreover, selecting a series of keys to expand a feature or a set of feature options may be required that typically takes more time and often causes a user to visually “search” for a feature through multiple layers of displays and/or across the entire surface area of the device.

### SUMMARY OF THE INVENTION

With the aforementioned problems or limitations in mind, the functionality provided by various aspects of invention includes new intuitive keypad and visual organizational layouts that provide better user control and guidance providing easier navigation to support advances in multimedia and electronic personal management functionality, including communication, while being straightforward, intuitive, and simple to use. The functionality provided by various aspects of the invention may provide greater user satisfaction of hand held electronic devices.

In one aspect, a user interface for an electronic hand held device is provided that includes a user input section having a plurality of keys dynamically configurable so that each key may be reassigned a functional role based on user selections, wherein at least a first subset of the plurality of keys is configured as touch sensitive keys in a substantially continuous circular arrangement, a controller configured to detect a touched location on the user input section and to control a display to visually present information related to a current location being touched wherein indicia is changeable on at least the first subset of keys based on user selections.

In another aspect, a user interface for an electronic hand held device is provided and includes a display to create images and text having a first display area and a second display area, a controller to control the images and text and a user interface that includes the display and a touch sensitive surface, the touch sensitive surface includes tactile delineations layered adjacent the first display area and the tactile delineations at least in part define a plurality of keys, wherein the controller receives indications of touched location indicative of one of the plurality of keys and initiates processing of a feature associated with the touched location, wherein the controller coordinates displays in the one of the first display area and the second display area, the first display area configured to provide indicia for the plurality of keys.

In yet another aspect, a method for providing a user interface for an electronic hand held device is provided and includes providing a user input section having a plurality of key locations dynamically configurable so that each key may be reassigned a functional role based on user selections, wherein at least a first subset of the plurality of keys is configured as touch sensitive keys in a substantially continuous circular arrangement, the dynamically configurable keys being configurable with dynamically assigned indicia, providing a controller to detect a location being touched on the user input section and to control a display to visually present information related to a current key being touched.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIGS. 1A and 1B are illustrations of an upper portion including a display showing partitioned portions and exploding menus, according to principles of the invention;

FIG. 2A is an illustration of an embodiment showing user input section, including a version of a tracer dial mode, according to principles of the invention;

FIG. 2B is an illustration of an embodiment showing a user input section for alpha dialing mode, according to principles of the invention;

FIG. 2C is an illustration of an embodiment showing a user input section configured in a modified dial mode, according to principles of the invention;

FIG. 2D is an illustration of an embodiment showing a user input section configured in a modified text messaging mode, according to principles of the invention;

FIGS. 3A-3B are illustrations showing a call tag sequence, according to principles of the invention;

FIG. 4 is an illustration of an embodiment showing a user input section configured with a “Back One” option and a “Start” option, according to principles of the invention;

FIGS. 5A and 5B are illustrations of an embodiment showing an “How To” option, according to principles of the invention;

FIG. 6A is an illustration of an embodiment showing a user input section configured in a dialing blind mode, according to principles of the invention;

FIG. 6B is an illustration of an embodiment showing a display related to a pass code entry, according to principles of the invention;

FIGS. 7A and 7B are illustrations of an embodiment showing a user input section configured in a VIP Personal mode and a VIP Business mode, respectively, according to principles of the invention;

FIG. 8 is an embodiment showing an example of the scrolling feature, according to principles of the invention; and

FIGS. 9A-9C are embodiments of a tracr user interface and display configured according to principles of the invention.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

It is understood that the invention is not limited to the particular methodology, protocols, devices, apparatuses, materials, applications, etc., described herein, as these may vary. It is also to be understood that the terminology used herein is used for the purpose of describing particular embodiments only, and is not intended to limit the scope of the invention. It must be noted that as used herein and in the appended claims, the singular forms “a,” “an,” and “the” include plural reference unless the context clearly dictates otherwise.

Unless defined otherwise, all technical and scientific terms used herein have the same meanings as commonly understood by one of ordinary skill in the art to which this invention belongs. Preferred methods, devices, and materials are described, although any methods and materials similar or equivalent to those described herein can be used in the practice or testing of the invention.

The dynamic functionality provided by the invention, especially in relation to the user interface, includes an intuitively arranged sequence of user key selections coordinated with visual displays to interact with feature operations of the hand held device.

The dynamic visual feature coordination of the electronic hand held device, the user interface of which is generally referred to as a “tracr,” is described herein in relation to the operation of a cell phone type device. However, the principles of the invention described herein may be similarly applied to related electronic hand held devices as well, and not limited to the exemplary cell phone device described herein for presentation of the provided tracr functional features.

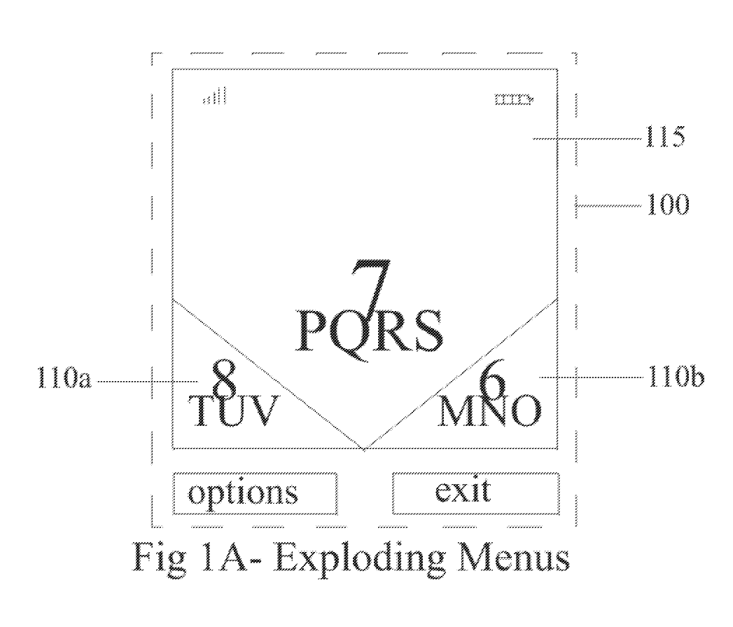

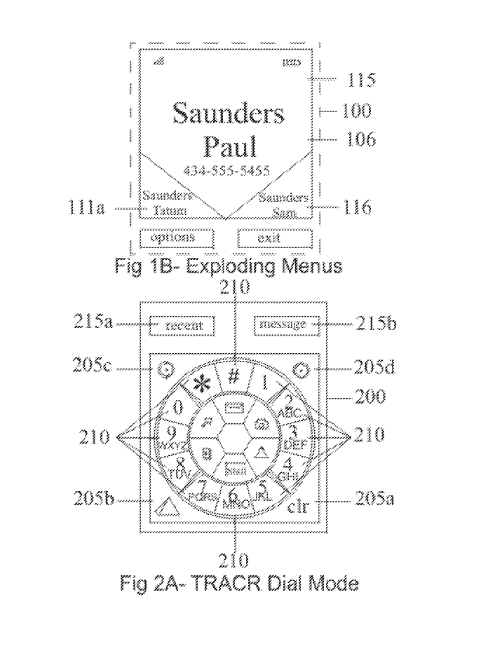

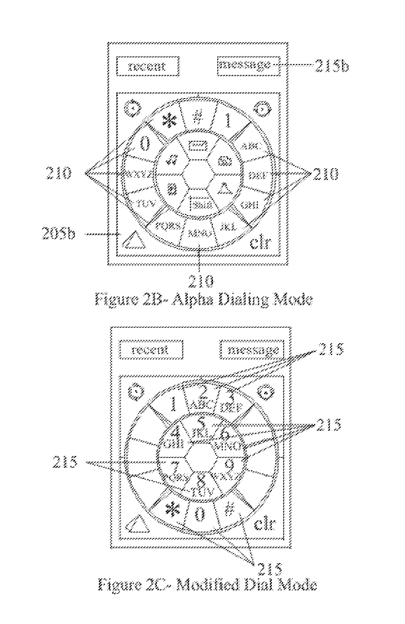

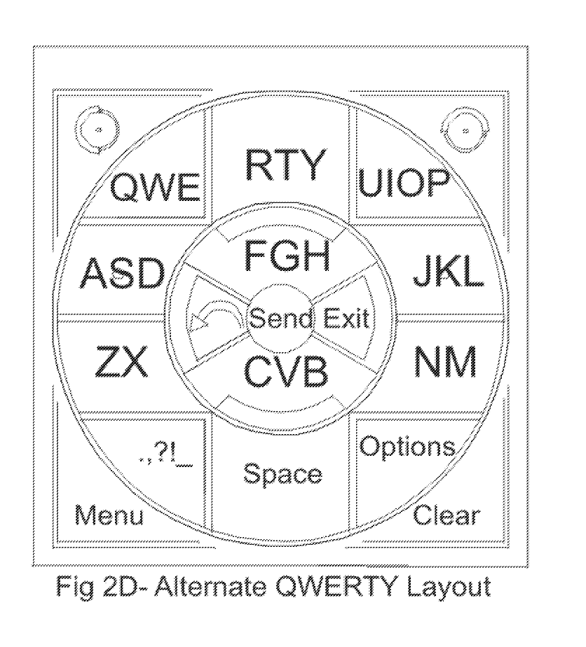

The face of tracr (i.e., outer visual surface) may be discussed using a number of terms associated with the device's layout. From a macro standpoint, tracr typically includes two main portions—the output section (i.e., display) may be located on the “upper portion” of the device (e.g., as designated generally by reference numeral 100 in FIG. 1), and an input section commonly located on the “lower portion” of the device, for example, as designated as reference numeral 200 in FIG. 2A. In some embodiments, the upper portion 100 and lower portion 200 may be housed in separate housings (not shown) that are joined together, perhaps by a hinge, swivel or slide to form the overall hand held tracer device. However, the upper portion and lower portion may be portions within a single housing, with a unified appearance. Alternatively, in a non-preferred embodiment, the upper portion 100 and lower portion 200 may be housed in two separate components, with electronic connectivity provided between the two portions. Moreover, the various features described herein may refer to functionality that necessitates specific hardware and software support (for example, not limited to camera functionality and global positioning system (GPS) functionality) and is presumed to be supplied by the hand held device as necessary.

The upper portion 100 includes a display 115, such as a liquid crystal display (LCD), or similar type of display, that may be dynamically partitioned into logical functional areas for dynamically displaying functional features as supported by the electronic hand held device and as selected or navigated by a user. The display may be configured to produce color images and/or text, black and white images and/or text, or grey scale images and/or text, as appropriate for a particular feature or application. Typically, but not necessarily always, the upper portion of the device may be a slave to the bottom portion of the device, that is, the lower portion can drive the upper portion in its output or display. Both portions typically, but not always, may be housed under one continuous touchscreen layer. For example, FIG. 1 is shown having three logical display areas 105, 110a and 110b, as described more below. However, the display may be partitioned as needed into one or more partitions dynamically by the on board electronics and software to visually present feature options and/or navigation feedback to the user during operation, as described more below.

Referring now to FIG. 2A, the input section of the lower portion 200 comprises multiple circular arrangements of keys, configured with a first circular arrangement of keys (i.e., keys 225a-225f) within another circular arrangement of keys (i.e., keys 210). One or more other keys (e.g., key 220) may be located within the multiple concentric circular key arrangements. Still other keys (e.g., keys 205a-d) may be located along the outer circumference of the outermost circularly arranged keyset (i.e., keys 210). Also, additional function keys, such as 215a and 215b, may be included as part of the lower portion 200.

The main circular keyset arrangement, generally designated as 210, having in this example twelve keys (but could be more or less in certain embodiments), may be configured so as to form a pattern generally in the arrangement of a traditional analog clock. However, in another embodiment, the indicia associated with the keyset arrangement may be configured in a conventional 3×4 cell phone matrix. It should be noted that the exact layout of the keys may be dependent on software, applications and other that may require modified versions of the traditional analog clock and a conventional 3×4 cell phone matrix.

Referring to FIG. 2A, the key designations on the twelve keys are shown in a preferred arrangement as keys 1-9, 0, *, and #, closely mimicking the layout configuration of a traditional analog clock (i.e., the “1” key is at the one o'clock position, the “2” key is at the two o'clock position, and so forth), with the placement of the “0”, “*” and “#” keys at the 10, 11 and 12 o'clock positions respectively. Note, also that traditional association of the alphabetic indicia on the “dialing keys” may be found in historical association with the traditional key layout. That is, alpha characters “A”, “B,” “C” are associated with key “2,” alpha characters “D”, “E” and “F” are associated with key “3,” and so forth, around the clock face layout, as many traditional telephony keypad associations has been known historically. The keys 210 may have fixed assignments (i.e., permanently assigned indicia), but preferably, the keys 210 (as well as the other keys on lower portion 200 and upper portion 100) may be flexibly presented as changeable displays, such as found with LCD type technologies, for example, with the key assignments and user readable indicia (alphanumeric text and/or icons) flexibly assigned by electronics driving the key displays (i.e., keys 210, 205, 215, 220, and 225).

### Exploding Menus

One aspect provided by the invention includes improved navigation through menus, showing “previous” and “next” options. The user interface provided by tracr may be configured to provide control functions to enable user interaction such as for making selections; these control functions may include: “Preview,” “Click” and “Scroll.” By way of example, and referring to FIGS. 1A and 2A, when a user moves a finger, stylus, thumb, or fingernail, etc. around the various keys on the lower portion 200, the electronics and software (generally, the “controller,” that provides overall computational control for the features supported by the hand held electronic device) senses and responds to the user's action. The controller determines the user's finger location and whether the finger is resting or moving among the keys of the lower portion 200 and may “explode” (expand visually the associated feature or features) at least one option on the display screen in the upper portion 100, along with the option just before and just after the current selection.

For example of “Preview,” during use, if the user's finger were traversing the main circular keyset arrangement 210, and the finger pauses on key “7,” the user would also see in the left lower corner 110a and right lower corner 110b of the display screen 115 the numbers “8” and “6” (alternatively, in other embodiments, the ordering might be reversed with the location of the numbers “8” and “6” reversed). This visual functionality should greatly reduce the number of misdials on the hand held unit and provides users the flexibility of knowing what key they are about to select even before it is depressed.

By way of another example, in reference to FIG. 1B, in view of FIG. 2A, FIG. 1B shows anticipation of information by presenting “current” key associated information (i.e., information related to a key where a user's finger is “currently” touching) when moving a finger around the Clock Face dial configuration of keys 210. Information associated with the currently touched key is shown as display portion 106, while a “previous” key is shown in portion 111a and “next” key information is shown in portion 111b. The “next” and “previous” keys may be a logical sequential or a physical sequential ordering in relation to the “current” key.

The circular nature of the layout of the keys 210 (and similarly keys 225) permits the anticipation and awareness of a “next” and “previous” key by the controller, since the keys are logically sequential, and/or physically sequential. This technique provides other subcategories of anticipation functions for providing visual navigational guidance. Two examples include “Last Touch” and “How To” utilities.

“Last Touch” is a functional feature that only allows the last option or key that a user touched to be returned as a user selection. For example, if a user's finger were resting on “2” for a predetermined time period (for example, 1 second), but the user actually presses “3” in quick succession (i.e., the touch time being less then the predetermined time on key “3”), tracr would recognize “2” as the operative key selection. However, “Last Touch” only works on adjacent keys; therefore if a user's finger were resting on key “2” and quickly depressed “4”, tracr would recognize the value “4,” since the “4” key is not sequential to the “2” key. Moreover, “Last Touch” feature may be turned off, if desired.

Operationally, the optional “How To” function operates to provide a visual ghosting of options. For example, if a user's finger rests for more than two seconds (or other predetermined time) on a key having a pre-assigned associated feature option, the feature option may be slightly ghosted (lightly displayed, or “grayed,” with or without the currently anticipated feature being shown) on the display 115. This “How To” option may be selected (e.g., using a designated key such as “toggle” key 220) and the feature or utility where the user's finger is currently resting then goes into a “How To” tutorial session which explains or expands how to use the feature (or part of the system) associated with the key where the user's finger was resting prior to selecting the “toggle” key. However, if the user were to simply press the current feature button (without selecting the “toggle” key), the “How To” feature would be skipped and the associated utility/feature selected.

For example, and referring to FIGS. 5A and 5B, if a user's feature were to rest on a “camera” key (an optional pre-assigned key such as key 205b), a “camera” icon may appear in display 115, and then the words “How To” would ghost over the “camera” icon, as shown in FIG. 5B. A user may either depress the “camera” key where the finger is currently resting, and get the “camera” option, or, the user may select “Yes” from a “toggle” button (may be any designated key in the lower portion 200 or upper portion 100, but is preferably located at a fixed or predetermined location for a particular type of electronic hand held device) which would launch the “How To” session on using the camera. In similar fashion, other types of features may also be supported by the “How To” feature, such as global positioning system (GPS) related functions, scheduling and calendar features, web based features, and communications related features, for example.

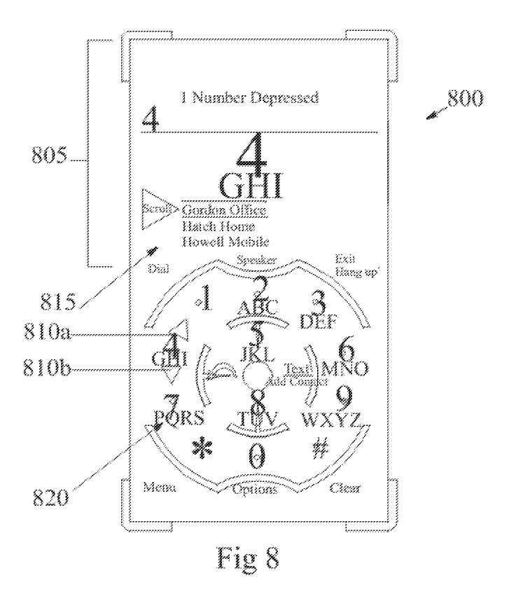

The embodiments of the invention may provide features referred to generally as “Preview,” “Click” and “Scroll.” “Preview” features may be achieved by the user touching a key. “Click” features includes the user actually depressing a key. “Scroll” features include when the user depresses a key and, instead of lifting their finger (which if lifted may activate that particular feature choice associated with that key), the user may glide into the next key or keyzone. Tracr may dynamically generate one or more scroll bars during the scrolling features that the user could operate to browse through options. Scrolling may be accomplished by moving the user's finger in a circular motion around the circular keypad(s) (clockwise or counterclockwise). FIG. 8 is an embodiment showing an example of the scrolling feature, according to principles of the invention, generally denoted by reference numeral 800. For example, a user may depress a key, such as the number “4” with its associated “GHI” indicia. The tracr device may register the “4” in the upper display area 805 and also open up the “GHI” section of the address book displaying any entries or certain portions 815 of the entries associated with “GHI.” The tracr device may dynamically put two arrows 810a, 810b on the face of the keypad, one being an arrow pointing upward, and a second arrow pointing downward. The arrows 810a, 810b may be located at any spot proximate the key pad area 820. The user may depress these arrows and begin to cycle through their address book with a circular motion of their finger, choosing which direction as appropriate using the upward or downward pointing arrow. It should be understood that the “Scroll” feature does not always involve the unit graphically or by other manner, showing an arrow symbol for the user to cycle through data or photos. For the advanced user, the scroll feature may be selected by depressing a key and releasing it in another key or keyzone.

Also, when the user depresses a letter from their address book, that particular letter may be enlarged on the keypad. As the user scrolls through their address book, going from one letter to another, the tracr device may keep on the keypad the exploded letter where the user is currently searching (and may dynamically change as the user moves through the address book). The user may depress that letter, move their finger around the dial, either forward or reverse, and skip through letters quickly (perhaps skipping 1 or more letters at a time) or can also “flick” their finger across the face of the tracr device and skip just 1 letter at a time. (Flick refers to quick detected movement across at least two keys to select or advance one iteration.) The display may show the letters exploding as you cycle through them. Once the user depresses a letter, the unit may resume cycling through names instead of letters (typically, but not always, 3 names, photos or data strings at a time).

### Dial Mode

In a preferred embodiment, much of tracr's input comes from touch sensitive input technology (e.g., a non-displaying touch sensitive panel with or without indicia, a displaying touch sensitive LCD panel, or similar touch sensitive technology). The touch sensitive membrane employed by the tracr user interface may include a resistive type touch sensitive configurations that detects touch at specific and discernable locations. (The touch sensitive technology referred to herein does not include mechanical type keys that require substantial force activation). In some embodiments, capacitive type touch screen membranes may be employed. Use of a touch sensitive technology coupled to a display provides for a marriage of input and display areas that co-exist in the same apparent space such as a common surface area of a device. This marriage also provides actual utility in that a particular key may dynamically change assigned function according to the selections of a user, the key indicia may also change dynamically providing new feature operations for the “new” key, depending on applications.

A characteristic of resistive touchscreens is that the a single X-Y coordinate may be ascertained that represents the location of the center of a keystroke force (centroid) in relation to the entire keypad so that if a majority of the “touch” (e.g., the most force detected of a finger press) is on the intended key, the correct character or utility may be selected. The centroid may be recognized correctly regardless of the area of the touch on the touch screen; thus, a stylus of arbitrary tip size and shape or a user's finger or thumb may report the same location on the touchscreen with the same degree of precision with even slight deviations of the stylus or finger. If the user's finger, which may be substantially larger at the tip than some arbitrary stylus, is touching near the border between two adjacent keys, the touch reported generally identifies the touch location as being on the key where more of the finger is touching, even though the border may be obscured by the user's finger and the finger is intercepting some of the region of an adjacent key.

The touch screen input pad is preferably a monolithic touch sensitive pad (“touch sensitive” includes being able to detect that a finger rests, even lightly, on a particular position of the input pad) with the keys preferably formed at least in part by tactile surface delineations and any associated dynamic indicia, and may be readable as individual keys by the associated electronics. In some embodiments, the keys may not always have tactile delineations between the adjacent keys in the same circular arrangement, although in some embodiments a “dimple” or embossed region might serve to delineate adjacent keys. Moreover, in some embodiments, the touch screen input pad may comprise a plurality of touch sensitive pads closely coupled to mimic a monolithic pad. In other embodiments, some input might come from non-touch sensitive inputs.

In certain embodiments, essentially the entire device surface may be touch sensitive, including the visual display areas. In preferred embodiments, key selection may be activated when a key is released (e.g., when a user's finger/thumb releases pressure on the pressed key to cause selection or activation of the feature associated with the key). The “upstroke” of the key (key release) provides for several features to operate, including “Scroll” and “How to.” In some embodiments, an audible feedback may be produced when a key has been selected, which may be turned on or off by a user. Moreover, in embodiments, an audible feedback may be given on a downstroke and also on the upstroke (perhaps distinctive for each), which may be user configurable as to whether this audible feedback occurs or not. In embodiments, a key depression may be confirmed by a physical tactile feedback (e.g., a “thump” or vibration that can be felt by the user). This may be generated by the same mechanism (perhaps a mechanical mechanism) that produces a vibration for alerting.

An example of a dial mode is also depicted in FIG. 2A. This mode populates the device from 1 to the 12 o'clock positions with the corresponding numbers as shown on a clock face. The 10, 11 and 12 o'clock positions are usually assigned the 0, * and # key respectively. Moreover, the corresponding alphanumeric letters may be slightly ghosted on the keypad with the appropriate key, as shown.

When dialing an alpha-numeric phone number such as 1-800-FLOWERS, for example, tracr provides the user an option to remove either the numbers or the letters from the keypad, as shown in relation to FIG. 2C. By depressing a “shift” button, for example (e.g., key 205b), while in the dial mode, the numbers on the main circular keyset 210 temporarily disappear, and the letters may be temporarily enlarged or otherwise enhanced. If a user were to depress the “shift” button again, the letters would disappear and the numbers would return in a default manner. So, if a user were dialing 1-800-FLOWERS, the user begins dialing “1800” while in the regular dial mode and then may depress the “shift” key which removes all numbers and may enlarge the letters for easier viewing and location of the letters for the word a user may be attempting to dial during the dial by name process. Moreover, the user may alternatively spell the word out using a text-like dialing program accessible through a menu or key selection.

Tracr users may be offered an opportunity to partake in a system “Set Up” once tracr is purchased and/or placed into service. This includes, but is not limited to, tutorials, contact setup including VIP lists (both business and personal, described below), selection of dialing mechanism (whether “Clock Face”, “3×4” matrix or other), text messaging mechanism (whether “Clock Face,” “3×4” matrix or QWERTY configurations, described below), setting up 4 digit pass codes as well as a host of other options. System setup is located in the menu area and may be restarted at any time. A “Clock Face” “3×4” matrix, or QWERTY keypad configuration may by dynamically selectable by a user.

### Modified Dialing & Text Messaging

Since tracr may provide a dynamically populated keypad with keys taking on different meanings depending on feature navigation, the user may define a preference in the manner of dialing. Referring again to FIG. 2A, which shows a “Clockface” mode, the configuration may be changed in the device's menu settings, to re-arrange the key configurations to be similar to a more typical “3×4” mode (like traditional prior art cell phones) as shown in FIG. 2C, keys 215. This “3×4” mode allows a user who may not want to change their dialing habits (perhaps since they are borrowing the electronic hand held device), and do not want to employ “Clockface” mode. Alternatively, if a user would rather enter “text” in the well-known QWERTY format, similar to a typical computer keyboard, the user may select an option of changing to a layout that simulates such a QWERTY layout, as shown in FIG. 2D.

In prior art devices, when a user wishes to text someone, the software and/or hardware allows the user to watch on the screen while typing and choose the appropriate word only if the device can accurately depict a word or phrase that is desired. Even then, the user must change keys to accept that word as the desired word. However, in contrast, on tracr the user may have the option of choosing the same word from above but this time instead of relying on software to “guess” the word, tracr allows the user to “choose” the word and never leave the “Clock Face” area, thereby eliminating the need to focus on another key in another location for entry. For example, if the user wished to type the word “where,” the user would depress the number “9” (‘WXYZ’) and hold the key down on the “Clock Face” and then, while still depressing the number “9,” typically with the same one finger slide across to either the number “8” or “0” key which would then activate “Word Messaging” and immediately populate the screen with words that begin with “W.” At this point the user may rotate around on the “Clock Face” until the word “where” was “exploded” on the LCD (on upper portion 100) and, with a quick depression on that key associated with “where,” may select that word and add it to the “working text message.” After that word is selected, the “Clock Face” would once again be populated in the same manner as found before. If the user fails to find the specific word, the user would lift their finger from the keypad and the tracr device repopulates the keypad with the prior set of options.

In the edit email or text message mode, the user may move the cursor around with their finger, thumb, stylus, fingernail, etc. The screen may show the exact location of the cursor by exploding the letters on the display where the cursor is located between as the user moves around the keypad and by highlighting by color or exploding (enlarging) on the screen the line where the user currently has the cursor as well as both adjacent lines (both above and below). This function may also be deployed on other functionality, such as reading email, browsing the web or any other function where large amounts of data are being reviewed or managed.

### Drive Mode

Next to the LCD 115 on the side of the upper portion 100 (or alternatively, the lower portion 200) may be three (3) keys (not shown) in straight-line succession usually embodying the same touch sensitive technology and actual physical depression characteristics as the rest of the device and are called the “Close Op” keys. These keys may offer the user an ability to perform certain functions with the device closed and control another subset while the device is open. One such subset that is controlled while open is the “Drive Mode.” By depressing and holding down any of the three successive “Close Op” keys for a specified time period, the user will enter the “Drive Mode.” “Drive Mode” is an audible feedback utility that allows the user the ability of knowing the entry chosen both before and after that key is depressed. For example, during the course of arriving at the entry “Paul Saunders” (as shown in relation to FIG. 1B) while in the “Drive Mode,” tracr gives an audible verification to the letters found in the address book as the user moves to the letter “S” (which corresponds to the numeric digit “7”). Once the user rests on the number “7,” an audible “7-P-Q-R-S” may be heard. The user, in this example, depressed the number “7” four times to arrive at the “S” section of the address book (it should be noted that if the user depressed the number “7” just once and began moving in a clock-wise manner on the “Clock Face,” the same end result may be achieved, but more entries would be traversed). Furthermore, if the user opted to depress the “S” directly, they would also arrive at this same position. At this point resting on each key and moving in a clock-wise manner leads the user to the entry “Paul Saunders” (as depicted in FIG. 1B). Tracr typically only gives the audible recognition to entries that have been rested on or “Exploded.” Once the entry is selected and tracr is about to “dial” that entry, an audible recognition of the entry may be heard—“Calling Paul Saunders 4-3-4-9-5-5-5-4-5-5.” This same audible recognition also exists for those users who are dialing single digits. When the user rests on each entry (numeric digits in this example), they may hear that number and, once all numbers have been chosen, may audibly hear the entire phone number as the unit dials, “Dialing 4-3-4-9-5-5-5-4-5-5.”

### Mini-Byte

This feature provides the user an ability to send a song byte, or a short clip of a song, to another user via audible text message. The song bytes may be divided into categories such as, for example, “Passion,” “Get Lost,” “Break Up” “Dissatisfied” and a host of other categories. Once a phrase is selected, for example “Dissatisfied,” a number of song bytes that encompass the meaning of the selected phrase would be available for sending to another user like, in this example, “Satisfaction” by the Rolling Stones. The song bytes are very short in length, usually a couple of seconds to about 30 seconds in length, and are a “Pay per Text” revenue stream to the carrier (Alltel, AT&T, etc). Furthermore, the user may also record their own byte by downloading the song and recording a section on their handheld tracr device.

### Tagging a Number

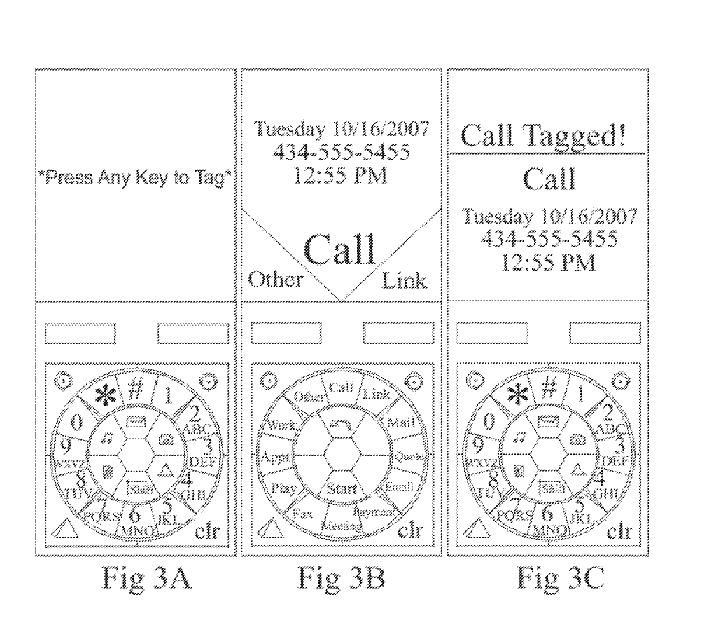

With tracr, when a phone call is received or an incoming call ignored, the tag feature in the phone may prompt the user to tag the number as seen in FIGS. 3A-3C. Options for the tag may include, but are not limited to, such phrases as “Call Back,” “Fax,” “Quote,” “Meet,” “Note” or the like. FIG. 3A shows the prompt related to entering a tag option. FIG. 3B shows that a “Call” tag is currently being considered for use as a tag selection. FIG. 3C shows that a “Call” tag has been set, with date and telephone number. These phrases may be included with the number, the time stamp of the phone call along with a reminder that will alert the user to this tag. If a specified or predetermined time period elapses before the user reacts to the phrase “Press Any Key to Tag,” the tag function could simply disappear. However, if desired the user can pull a number from a “Call History” list and tag it manually at any time. It should also be understood that the user can “tag” or mark an incoming call in a similar manner.

By way of an example, often a user may be “in the field,” office, “on the road,” on another call or just busy and receives a phone call, perhaps even a second call while handling a first call. But a user may have difficulty remembering the caller's number (perhaps no paper or pen), what the call was about and/or, perhaps more importantly, to return a call from the caller, especially when the issue is important, for example.

With the functionality provided by tracr, when a phone call is received, the “tag” feature may prompt the user whether or not they wish to tag the caller's number. Standard options for the “tag” feature include such phrases as “Call Back,” “Fax,” “Quote,” “Meet.” Other predetermined “tags” may be provided, either as standard with the hand held electronic device, or the “tags” may be pre-created or personalized by the user in a separate programming mode, recallable for use as described above. In operation, when a tag is applied to a call by a user, the “tag” phrases (or equivalent indicator) may be stored in a memory in the hand held device along with the caller's telephone number, a time stamp of the phone call, along with a reminder that alerts the user to this “tag.” However, if desired the user can pull a number from a “Call History” list and tag it manually at any time. The tagged calls may be subsequently retrieved for follow-up or reminders may be generated to follow-up with a tagged call.

### Tracing a Contact

Another operational sequence provided by tracr includes the ability of exchanging phone numbers. During a call, when contact information such as a phone number is verbally requested from another tracr user (i.e., two tracr devices involved in a conversation or communication), the contact information may be sent via a “text-like” message with the number attached. The mode of transfer may vary depending on the available communication facility for the call in question and technology capability of the two end parties. For example, the number may be delivered by DTMF tone, sub-audible tone, or Internet messaging such as instant messaging. When the requested number is received, the user is prompted to either dial the number or save it in a local memory such as an “address book,” for later recall. The information may include any variation of user information such as address, multiple phone numbers, Internet address, contact card information including any relevant company information, and the like. The exchange may also include other types of information such as map or directions, or even one or more links to a web site for other relevant information. When the contact is being saved (or after), the user may modify any part of the contact information.

### Call Text/Redirect

The “Call Text/Redirect” features are both powerful options that allow the user to answer a phone call with a specific message, or redirect the phone call to another number. For example, in current telephone systems, if a user were “on a job” or “were in the middle of a meeting with an important client,” for example, when a phone call appears with caller ID, the user could either ignore the call (which could lead to repeated calling) or answer it (which often times appears rude to others with whom the user may be engaged). With tracr's “Call Text,” a user may select an appropriate “Text Phrase” that is instantly sent to the other user's phone. Such messages might include, for example, “In Meeting,” “Busy—will call back later,” or any number of other phrases that can be pre-programmed.

Another example of “Call Text” includes when a user is “on a job” (remote from an office perhaps), for example, and a client called that wanted some information from the user that another person such as an office manager could handle. The called user may depress the “Redirect” option on the tracr unit and then the user's office number from the contact list. The call and the caller may be routed to the user's office where the call can receive appropriate attention. This feature may also make use of central office or cell phone controller functionality at least in part to complete a call transfer.

### Insta-Trace

This feature allows multiple users to send and receive instant messages on a tracr. In order for this feature to work, two or more tracr units must be synced so that the units involved recognize each other and the associated user names. Each user has a screen name (acquired during the sync process) associated with their phone number which will appear on the associated mobile unit of another participant along with corresponding comments/dialogue. Unlike the current text messaging mode of prior art mobile devices, “Insta-Trace” has been synced with other tracr phones thereby eliminating the need to choose recipients when sending.

### DTMF

One is not always in a position or a place where they can make a note about a phone number from the office, from the road or while playing with your grandchildren, for example. It is these times that the DTMF mode of tracr particularly offers value. A user may receive a call. The caller immediately gets the instructional text phrase “Input Number Now” directed to their phone (via a inter-tracr communications message)—the caller depresses the appropriate telephone number to be sent into their touchtone keypad, and the called tracr records the number with a timestamp and the caller's received phone number. In this way a call back number may be entered into a called party's phone book. Subsequently, the called party may open the recorded numbers, and be prompted to optionally dial the number to return the call, but also prompted to save the number into the user's address book.

### Back One and Start

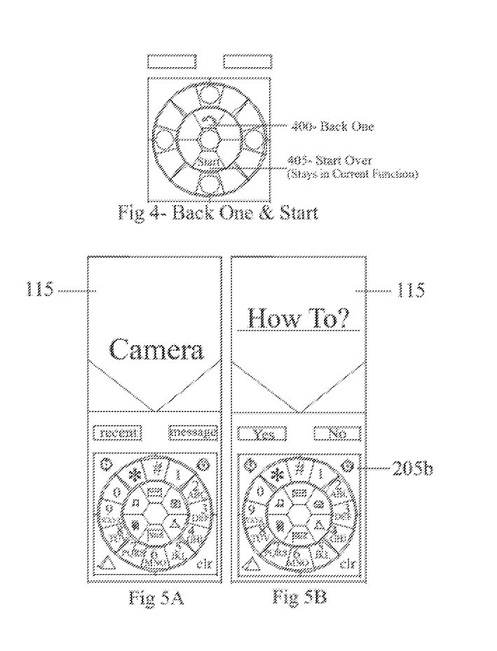

While in most utilities on tracr, the user typically has two options to back them up one step as shown in the embodiment of FIG. 4, or to go back to the beginning of the utility. For clarity, FIG. 4 only labels the keys related to the “Back One” and “Start” option, but other keys should be assumed to be present, such as those keys related to FIGS. 2A-2d.

An example is now given to explain the “Back One” and “Start” features. If a user were in the “camera” mode and had selected the key sequence of Cloudy+Indoors+Timed Shot (which sets several camera parameters), but the user did not intend to select the last option (Timed Shot), the user may press the “Back One” key 400. Tracr would retract the entered selection by one entry and the resulting selections would be Cloudy+Indoors. If, however, a user were not even close to a desired sequence, and had chosen incorrectly, but still wanted to remain in “camera” mode, the user may depress the “Start” key 405. Tracr resets the input mode as if the user were beginning the “camera” mode utility. That is, all key selections from the point of entry of the “camera” mode are cancelled. The “Start” function may be employed with other functional sequences as well.

### Dialing Blind

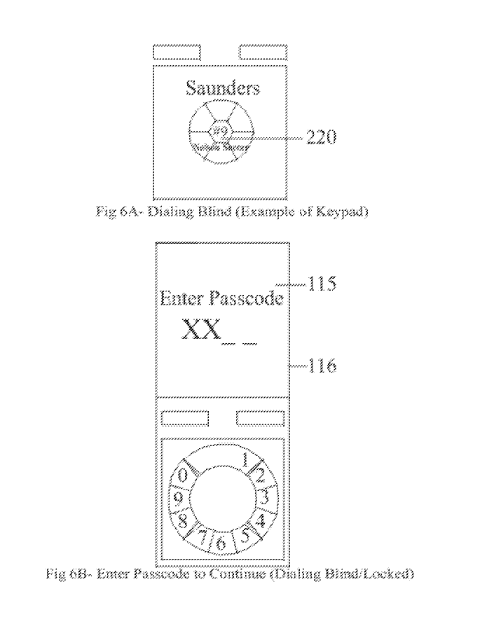

Since all of the information under each key may be dynamically generated based on the utility that a user chooses, the user may also decide to not have any info shown on any key at all. This option is generally called “Dialing Blind” and is illustratively represented in FIG. 6A. This mode allows a user, in lieu of traditional type of indicia on the dynamically assignable keys, to instead assign to the keys and or the entire display (key pad and display) one or more of: a picture of their favorite pet, tattoo, boyfriend or girlfriend or some phrase that they have personally chosen, or leave the keys blank. The user still would know exactly where they are in each utility due to tracr's “Preview” and “Exploding Menus,” which would still function as described previously. While in the “Dialing Blind” mode, the user may re-populate their keys with tracr indicia, by touching the device at any time.

This feature, “Dialing Blind” also allows the user to lock their phone, thereby eliminating unauthorized use. When the phone is locked with a 4-digit pass code, the phone immediately goes into either the default “Dialing Blind” picture or the one chosen by the user. Once locked, if a key is depressed tracr illuminates only the numeric entries on the screen thereby awaiting the 4-digit pass code to continue/unlock the unit, as shown in relation to FIG. 6B. Once locked, if a key is depressed tracr illuminates a possible subset of pass-code options including, but not limited to, numeric entries thereby awaiting the 4-digit pass code to continue/unlock the unit, as shown in relation to FIG. 6B. Other possible subsets for pass-codes may include colors, photos, letters and figures—any of which when depressed in the correct sequence, unlocks/locks the unit. FIG. 6B also shows a combined unit where the upper and lower portions are connected in housing 116. The housing 116 may include the electronics and software (not shown) to perform and control the various features and functions described herein. The electronics typically includes an appropriate processor and related memories (perhaps including a removable type memory) for software execution related to onboard feature control and execution including but not limited to the software related features described herein, and short and long term data storage. The electronics may include one or more of various communications interfaces such as a wireless interface for voice an/or data communications, a universal serial bus (USB) interface, infrared or blue tooth interface, for example. The onboard software may be upgradeable through any of these interfaces and/or removable memory.

Dialing blind may also include an option where a user may create a collage or grouping of photos on their keypad and/or entire tracr device. These photos may be a pseudo screen-saver in that as the user touches the tracr device in a particular area, the touch may create a ripple effect (e.g., visual expansion or fading of the collage) on the graphic overlay of the device, on the entire device or just in the touched area only, thereby revealing the option(s) found beneath the collage of photos. Young people, often with their keen sense of handheld devices, may use this option since they intuitively already know where the keys are located and the options associated with those keys.

In some modes, the tracr device may provide a graphic overlay with only a subset of keys visible such as a couple of keys visible. Therefore, if a phone call was incoming and it had a photo associated with it (e.g., based on the caller-ID or other identifier of the incoming call to locate and display the appropriate picture), the user may see the photo of the incoming caller, with any appropriate options for accepting, ignoring, or receiving the call, perhaps with the available feature keystroke options overlayed on the entire display, perhaps including the photo itself.

### VIP Business/Personal Auto Populate

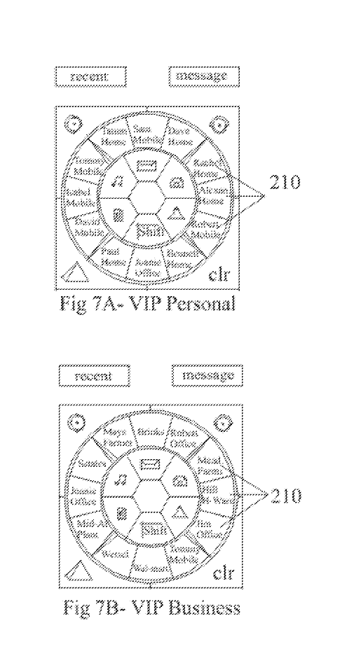

The average user during a day at work, for example, dials a relatively short list of contacts on a daily basis. In order to take advantage of this, tracr offers a VIP Business & Personal screen. While in this mode as shown in relation to FIGS. 7A and 7B, the top 12 contacts are auto-populated onto the “Clock Face” based on usage and/or user input/selection. In this mode, the user may rest a finger on the key having this option and immediately an exploded version of the entry appears on the key, as shown in relation to keys 500.

The address book can be broken down into subsets based on usage, user selection or other criterion. Similarly, these subsets can be programmed by the user to dynamically populate the “Clock Face” based on time of day and day of week. For example, from 7 AM till 6 PM, Monday-Friday the unit will be in the VIP Business mode (see FIG. 7B), while from 6 PM till 7 AM Monday-Friday and all day Saturday and Sunday the unit will be in VIP Personal (see FIG. 7A). Navigation between the complete list, Address Book, and these VIP subsets is embodied in the Address Book and can be accessed in the menu section and subsequently by depressing the shift key.

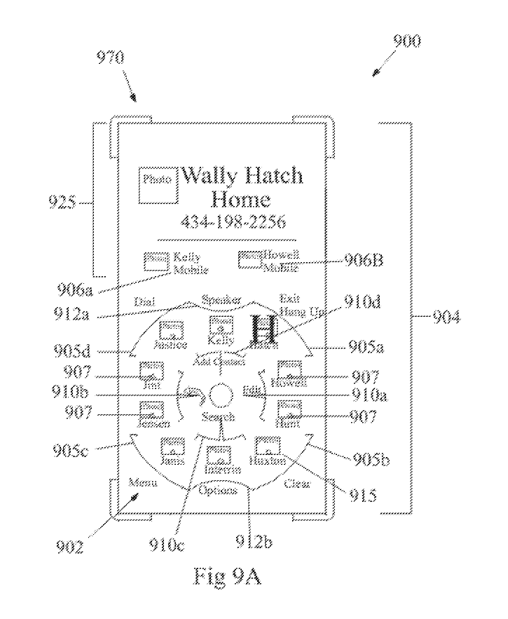

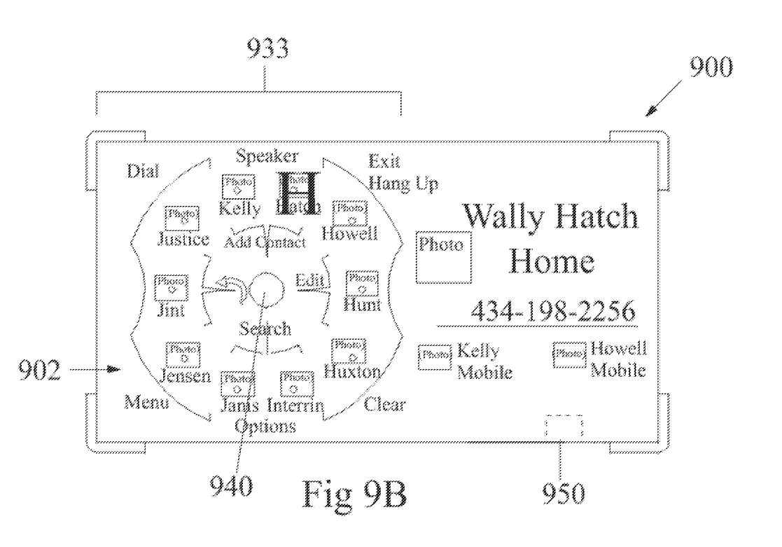

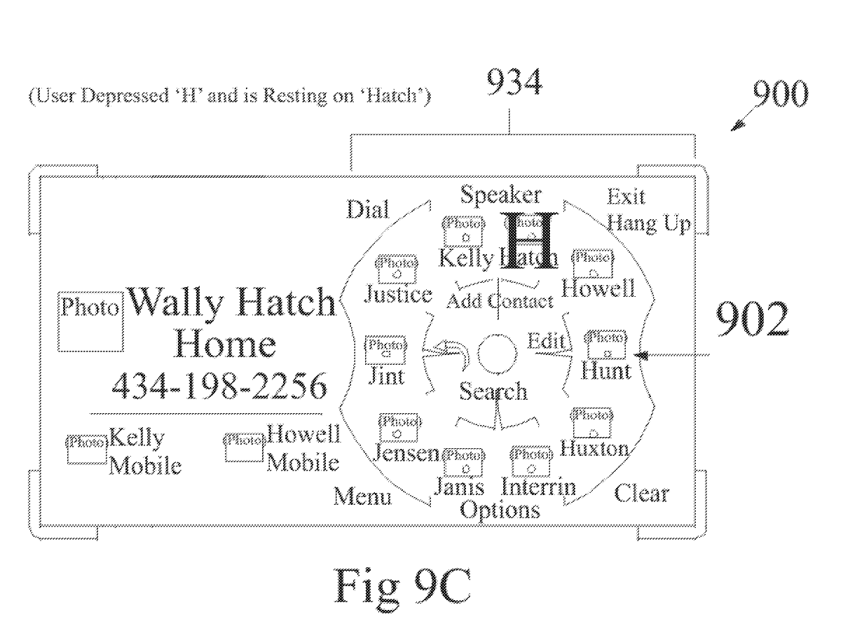

FIGS. 9A-9C are embodiments of a tracr user interface and display configured according to principles of the invention, generally denoted by reference numeral 900. The embodiment of FIG. 9A shows the tracr user interface and display oriented in a portrait mode with the dial pad area 902 configured at the bottom, while the embodiment of FIG. 9B shows the tracr user interface and display oriented in a landscape mode with the dial pad area 902 configured on a left hand portion 933, while the embodiment of FIG. 9C shows the tracr user interface and display oriented in a landscape mode with the key pad area 902 configured on a right hand portion 934. The embodiment of FIG. 9B may be more suitable for a left-handed user, while the embodiment of FIG. 9C may be more suitable for a right-handed user. The electronic hand held device employing the tracr interface may include a top surface configured to display text or images essentially anywhere on the top surface. The embodiments of FIGS. 9A-9C are each dynamically selectable by a user to change from one mode to another while still making use of the same tactile surface delineations for user feature selection and feature operations. In some embodiments, the hardware and/or software associated with tracr may automatically detect an orientation change of the hand held device and automatically change modes from portrait to landscape or from landscape to portrait, with proper orientation of the text for which ever direction is “up” when in landscape mode. The tracr user interface 900 of FIGS. 9B and 9C are substantially symmetrical images of one another. The software controlling the tracr displays, controlling the key pad operations and user selections compensates for the particular landscape mode, and displays images and text in conformance with the selected landscape mode so that the images and text are displayed in the correct orientation, and key selections are identified in conformance with the currently selected mode. In portrait mode, the software adjusts accordingly to display text and images, and receive input, as appropriate to a portrait mode. In landscape mode the text and displays are configurable to be readable with the keys proximate a first end (perhaps the left end) of the electronic device employing the tracr interface and may be configurable to be readable with the keys proximate a second end (perhaps the right end) of the electronic device employing the tracr interface. The processor 950, perhaps a microcontroller with appropriate memory and electronics, and associated software may control the orientation of the landscape and portrait presentations. The processor 950 or similar computer processing device(s) may also perform many if not all of the features of the embodiments shown herein. All the embodiments herein employ such a processor or computing device. In some embodiments, the processor 950 may coordinate feature operations with another computer of the electronic hand held device 970 or even a remote computer. The processor 950 may receive indications of touched location indicative of one of the plurality of keys and initiates processing of a feature associated with the touched location.

The tracr user interface 900 including a display 904 may include various tactile surface delineations such thumb guide 905a-905d which may include a top radius portion 912a and a bottom radius portion 912b. Dimples 907 may be present and associated with each configured key. A second inner circularly arranged set of keys may be configured as denoted by the “Search, “Edit,” “Add Contact” and “back arrow” designations. A “execute” or “home” key 940 may be configured at the center for execution of select features. Some features may provide a thumbnail photo 907 which may be associated with each key or subset of keys. These keys may be resistive touch sensitive keys. The tracr user interface 900 may include the display and a resistive touch sensitive surface, the touch sensitive surface may include the tactile delineations layered adjacent a first display area (the first display area may be configured under the plurality of keys while a second display area 925 may be configured above the keys for displaying general information) and the tactile delineations at least in part defines a plurality of keys. As shown, an upper display area 925 may display information related to a current feature, perhaps in response to user action. As shown, the entire top surface of the electronic hand held device 970 employing the user interface 900 may essentially include a display.

The software organization of the tracr based functions may also provide for minimizing keystrokes lengths and number of depressions by nesting menus within menus (that is, allowing the user to make a selection on the “clock face” and then having the first option available to them nested directly beneath the new dynamically created key or option). Also, in any audible mode such as listening to music or receiving an alerting sound, for example, the user may increase or decrease the volume level by moving their finger around these circularly arranged keys.

The exemplary feature being shown in the embodiments of FIGS. 9A-9C is of the address book. The address book feature may be entered from a top level selection (not shown) such as from a main top level menu. A finger of the user may be causing a preview of Wally Hatch by resting on Wally's associated key which in this example is key number 1. Also shown are thumbnail photos of various other contacts as associated with the various keys. On the upper display area 925, information related to Wally Hatch may be displayed, perhaps including his photo. Options 906a, 906b show the previous and next options related to the current previewed option. If the user were to move their finger around the clock face clockwise to a next location, the information associated with Howell would be displayed in the upper display area 925 and the options 906a, 906b would be updated to show the new previous and next options.

The examples given above are merely illustrative and are not meant to be an exhaustive list of all possible embodiments, applications or modifications of the invention. Thus, various modifications and variations of the described methods and systems of the invention will be apparent to those skilled in the art without departing from the scope and spirit of the invention. Moreover, U.S. patent application Ser. No. 12/364,263, filed Feb. 2, 2009, entitled ERGONOMIC USER INTERFACE FOR HAND HELD DEVICES, is incorporated by reference herein.

Although the invention has been described in connection with specific embodiments, it should be understood that the invention as claimed should not be unduly limited to such specific embodiments. Indeed, various modifications of the described modes for carrying out the invention which are obvious to those skilled in the art or related fields are intended to be within the scope of the appended claims.

What is claimed is:

1. A user interface for an electronic hand held device, comprising:
a user input section having a plurality of keys dynamically configurable so that each key may be reassigned a functional role based on user selections, wherein at least a first subset of the plurality of keys is configured as touch sensitive keys in a substantially continuous circular arrangement;
a controller configured to detect a touched location on the user input section and to control a display to visually present information related to a current location being touched
wherein indicia is changeable on at least the first subset of keys based on user selections.

2. The user interface of claim 1, further comprising a second subset of the plurality of keys configured as touch sensitive keys and arranged concentric with the first subset of the plurality of keys.

3. The user interface of claim 1, wherein the controller is configured to display indicia on each of the plurality of keys.

4. The user interface of claim 1, further comprising a display controlled by the controller to display feature related options.

5. The user interface of claim 4, wherein the display is logically partitioned into a first portion that corresponds to a function related to a current key defined by a current finger location on the user input section, a second portion that corresponds to a function related to a previous key, the previous key being a key one less in order than the current key, and a third portion that corresponds to a function related to a next key, the next key being a key one greater in order than the current key.

6. The user interface of claim 5, wherein the previous key, the current key and the next key are in logical consecutive order.

7. The user interface of claim 5, wherein the previous key and the current key are in physical adjacent order and the current key and the next key are in physically adjacent order.

8. The user interface of claim 1, wherein the controller detects a “last touch” function, wherein the “last touch” function causes a previously touched key to be selected and processed, based on an option setting.

9. The user interface of claim 8, wherein the option setting turns the “last touch” function on and off.

10. The user interface of claim 8, wherein the option setting defines a timing parameter for detecting the last touched key as compared with a currently touched key.

11. The user interface of claim 1, wherein the controller controls a “How To” feature, the “How To” feature causing a display inviting a user to select a feature tutorial related to a currently touched key.

12. The user interface of claim 11, wherein the display is performed using a ghosting effect.

13. The user interface of claim 1, wherein the controller controls the presentation of the plurality of key locations dynamically to configure the plurality of key locations as a clock face arrangement with other keys nested both inside and outside of this arrangement.

14. The user interface of claim 1, wherein the controller controls the presentation of the plurality of key locations dynamically to configure the plurality of key locations as one of a “3×4” arrangement and a substantially QWERTY simulated configuration.

15. The user interface of claim 1, wherein the controller detects a user key operation associated with a “tagging” feature so that a received or ignored call is logged with a tag with a predefined phrase for use in later follow up of the call.

16. The user interface of claim 1, wherein the controller receives information during a call and logs the information as text for later recall.

17. The user interface of claim 16, wherein the information is received via one of: DTMF, Internet type messaging and sub-audible tone.

18. The user interface of claim 1, wherein the controller initiates redirection of an incoming call to another destination via one or more key depressions.

19. The user interface of claim 16, wherein the controller returns text selected by a user to a caller.

20. The user interface of claim 1, wherein the controller detects a “back one” function selection and retracts the last key selection of a user, other that the “back one” selection.

21. The user interface of claim 1, wherein the controller detects a “start” function selection and resets a functional feature key selection sequence to a know starting point, ignoring any key selections since the know starting point.

22. The user interface of claim 1, wherein the controller detects a “dialing blind” function and removes any indicia from either a portion of the plurality of key locations or the entire device.

23. The user interface of claim 1, further including:
the display, wherein the user input section is configured on the display, wherein the display provides the indicia for the plurality of keys.

24. The user interface of claim 1, wherein a depressed key of the plurality of keys causes a physical tactile feedback.

25. The user interface of claim 1, wherein the orientation of the indicia and the orientation of images on the display is configurable to be presented in portrait mode or landscape mode whereby the landscape mode is configurable for either a right or left-handed user.

26. The user interface of claim 25, wherein the landscape mode is configurable to create readable text and displays with the plurality of keys located proximate a first end of the hand held device and is configurable to create readable text and displays with the plurality of keys located proximate a second end of the hand held device, the landscape mode configuration being selectable by the user.

27. The user interface of claim 1, wherein the plurality of keys are at least in part defined by a tactile delineation on a surface of the user input surface, the tactile delineation having a radius around at least a portion of the plurality of keys.

28. The user interface of claim 1, wherein at least the first subset of keys are identifiable by a dimple tactile feature.

29. The user interface of claim 1, wherein the electronic hand held device has a top surface and the display is configured to create images or text essentially at any location on the top surface.

30. The user interface of claim 1, wherein the touch sensitive keys are resistive touch sensitive keys.

31. A user interface for an electronic hand held device, comprising:
a display to create images and text having a first display area and a second display area;
a controller to control the images an text; and
a user interface that includes the display and a touch sensitive surface, the touch sensitive surface includes tactile delineations layered adjacent the first display area and the tactile delineations at least in part define a plurality of keys,
wherein the controller receives indications of touched location indicative of one of the plurality of keys and initiates processing of a feature associated with the touched location,
wherein the controller coordinates displays in the one of the first display area and the second display area, the first display area configured to provide indicia for the plurality of keys.

32. The user interface of claim 31, wherein the touch sensitive surface comprises a resistive touch sensitive surface.

33. A method for providing a user interface for an electronic hand held device, the method comprising the steps of:
providing a user input section having a plurality of key locations dynamically configurable so that each key may be reassigned a functional role based on user selections, wherein at least a first subset of the plurality of keys is configured as touch sensitive keys in a substantially continuous circular arrangement, the dynamically configurable keys being configurable with dynamically assigned indicia; and
providing a controller to detect a location being touched on the user input section and to control a display to visually present information related to a current key being touched.

34. The method of claim 33, wherein the step of providing a user interface includes providing a second subset of the plurality of keys configured as touch sensitive keys arranged in a circular fashion within the first subset of the plurality of keys.

35. The method of claim 33, wherein the touch sensitive keys comprise resistive touch sensitive keys.
